(19) United States
(12) Patent Application Publication
(10) Pub. No.: US 2010/0332051 A1
(43) Pub. Date: Dec. 30, 2010

(54) Control Arrangement For Controlling The Transfer Of Agricultural Crop From A Harvesting Machine To A Transport Vehicle

(76) Inventor: Georg Kormann, Zweibrucken (DE)

Correspondence Address: DEERE & COMPANY, ONE JOHN DEERE PLACE, MOLINE, IL, 61265, US

(21) Appl. No.: 12/784,013

(22) Filed: May 20, 2010

(30) Foreign Application Priority Data
Jun. 26, 2009 (DE) 10 2009 027 245.3

(51) Int. Cl. G06F 7/00

(52) U.S. Cl. 701/2; 701/50

(57) ABSTRACT

A control arrangement is provided for controlling the transfer of agricultural crop from a harvesting machine to a transport vehicle, the transport vehicle comprising a loading container. The control arrangement based on signals from a sensor arrangement detects the fill level and/or the outer contours of the loading container and controls the position of the output end of a discharge device with respect to the harvesting machine and/or the ejection direction of the discharge device, and/or the position of the transport vehicle with the loading container with respect to the harvesting machine, automatically in such a manner that the loading container is successively filled with the crop. It is further proposed that the sensor arrangement is designed to detect the position of a second loading container and that the control arrangement can be operated so that after detection of an overall sufficiently filled first loading container, the discharge device will be automatically aligned to the second loading container based on the signals from the sensor arrangement.

### FIELD OF THE INVENTION

The invention relates to a control arrangement for controlling the transfer of agricultural crop from a harvesting machine to a transport vehicle. The transport vehicle having a loading container. The control arrangement being operated based on signals from a sensor arrangement detecting the fill level and/or the outer contours of the loading container, so as automatically to control the position of the output end of a discharge device with respect to the harvesting machine, and/or the ejection direction of the discharge device, and/or the position of the transport vehicle with the loading container with respect to the harvesting machine, in such a manner that the loading container is successively filled with the crop.

### BACKGROUND OF THE INVENTION

When harvesting agricultural crops in a field, it is current practice that a harvesting machine loads with harvested crop, a transport vehicle driving along next to it. A loading container of the transport vehicle, which can be, for example, a tractor with trailer or a truck, is loaded with the harvested crop from a discharge device of the harvesting machine while driving, for example, in the case of a forage harvester, by a discharge chute, and in the case of a combine-harvester, by a discharge tube. The discharge device generally can be rotated about a vertical axis and is fastened to the harvesting machine to pivot between an idle position in which it is oriented roughly parallel to the longitudinal axis of the harvesting machine, and a working position in which it extends transverse to the driving direction of the harvesting machine. In addition, the height of the discharge end of the discharge device can be varied, as can be the position of an ejection flap which defines the angle at which the harvested crop is discharged.

In the case of adjustable discharge devices, like those commonly used in forage harvesters, the position of the discharge device in the simplest case is controlled manually by the driver of the harvesting machine, in which case input devices are available in the drivers cab which control actuators used to adjust the discharge device. In this case the driver of the harvesting machine must take care that the entire loading container of the transport vehicle is sufficiently filled, which is performed by successive aligning of the discharge device to different points on the loading container. If the transport vehicle deviates forward or backward or to the side from its target position, then the position of the discharge device has to be manually corrected. In addition, the driver of the harvesting machine must check the fill status of the loading container and initiate a change of the transport vehicle when the loading container is sufficiently filled. This takes place, for example, in a manner such that the driver of the transport vehicle determines, based on a hand signal or another signal from the driver of the harvesting machine (or automatically if he can detect that the loading container is filled) to reduce speed; another transport vehicle drives up next to the harvesting machine and then the discharge device is directed toward the loading container of the other transport vehicle, wherein in the meantime, the harvested crop drops onto the ground and the production chain is broken. Or it may be the case that two transport vehicles drive along beside the harvesting machine and the driver of the harvesting machine—when the loading container of the first transport vehicle is sufficiently filled and which is usually driving along next to the harvesting machine—directs the discharge device to the loading container of the second transport vehicle driving along next to the first transport vehicle. The first transport vehicle then reduces its speed, turns away, and the second transport vehicle then drives right up next to the harvesting machine. The disadvantage of this procedure is that the control of the position of the discharge device and monitoring of the fill level of the loading container takes up a considerable amount of the driver's attention, which leads to work fatigue. The change in the discharge device from the first transport vehicle to the second transport vehicle is a difficult operation that requires experience and skill in order to avoid losing harvested crop material.

DE 44 03 893 A1 describes a forage harvester with a discharge device on whose output end there is a distance meter that detects the height of the harvested crop in the loading container. As soon as the crop has reached a preset height, the discharge device is adjusted until the entire loading container is filled. In this case an essentially automated operation occurs, which is a relief for the driver of the harvesting machine; however, a manual alignment of the discharge device to the second transport vehicle is still required once the loading container of the first transport vehicle is filled.

EP 1 219 153 A2 proposes that the loading container be moved automatically or manually with respect to the harvesting machine into a position in which it can be filled. In the case of rigid discharge devices (combine-harvester) by means of a remote data transmission device, positioning information on the discharge device is passed to the transport vehicle and the position of the transport vehicle is adjusted, while moving discharge devices (forage harvesters) are automatically brought into a position in which they fill the loading container, based on data regarding the position of the loading container and the position of the discharge device. If the driver determines that one region of the loading container is sufficiently filled with crop and that now a different region is to be filled, then the driver of the harvesting machine will change the position of the discharge device manually. If the range of motion of the discharge device is no longer sufficient to reach as yet insufficiently filled regions of the loading container, then the relative position of the transport vehicle to the harvesting machine will be changed automatically, which can also occur opposite to the discharge device. If the loading container of a first transport vehicle is filled, then the operator initiates a change of the transport vehicle or an automatic change of the transport vehicle is initiated, based on an overloaded quantity of material. Accordingly, the discharge device is automatically and constantly aligned to a defined position on the loading container, but the driver of the harvesting machine is relieved of the task of monitoring the collecting cone of loose, bulk crop on the loading container and of having to bring the discharge device into a new position if the cone of bulk crop increases too much.

EP 20 20 174 A1 describes a forage harvester with a camera arranged on the outer end of the discharge device and which detects the characteristic parameters of the discharge device and of the harvesting machine and/or of the transport vehicle. The camera can also be designed for distance measurement and to detect the fill level of the loading container. The signals from the camera are used to control the position of the discharge device and/or of the transport vehicle automatically with respect to the harvesting machine, in such a manner that the loading container is filled automatically. With regard to the change in discharge device to a loading container of a second transport vehicle, the disadvantages mentioned with respect to DE 44 03 893 A1 are still present.

Accordingly, there is a clear need in the art to create a control arrangement for controlling the transfer of agricultural crop from a harvesting machine to a transport vehicle having a loading container, which is capable of firstly controlling the position of the discharge end of the discharge device, and/or the discharge direction of the discharge device, and/or the position of the transport vehicle with the loading container with respect to the harvesting machine, automatically in such a manner that the loading container is filled with the crop preferably according to a suitable loading strategy, and secondly also which offers the potential to align the discharge device automatically to the loading container of a second transport vehicle when the loading container of a first transport vehicle is filled.

### SUMMARY OF THE INVENTION

A control arrangement is used for controlling the transfer of harvested agricultural crop from a discharge device of a self-propelled or towed or attached harvesting machine to the loading container of a transport vehicle. During the harvesting operation and based on signals from a sensor arrangement detecting the fill level and/or the outer contours of the loading container, the control arrangement affects the position of the output end of the discharge device and/or the ejection direction of the discharge device and/or the position of the transport vehicle with respect to the harvesting machine. The latter occurs in that the control arrangement sends steering and/or speed signals to a steering and/or speed definition device of the transport vehicle or to a suitable display and/or a loudspeaker on the transport vehicle, based on which the driver of the transport vehicle will steer and/or control the speed of said transport vehicle. In this case the crop will be placed automatically by the control arrangement successively at different locations of the loading container according to a loading strategy.

The sensor arrangement detects not only the fill level and/or the contours of the loading container, but rather also is capable of detecting the position of a second loading container, to the extent that it is located sufficiently close to the harvesting machine. The second loading container can be moved across the field from a second transport vehicle or from the first transport vehicle. As soon as it is determined that the first loading container has reached a pre-determined, target fill level, the control device will automatically align the discharge device to the second loading container by using the signals of the sensor arrangement. Now the first transport vehicle will be decelerated by the driver (automatically once he detects the pivoting of the discharge device to the second loading container, or directly by means of the control arrangement via the steering and/or speed definition device of the transport vehicle or initiated by suitable instructions on the display or from the loudspeaker) and leaves the harvesting machine in order to move the crop to a collection area, while the second transport vehicle assumes the position previously held by the first transport vehicle, i.e., at the side of the harvesting machine. If the first transport vehicle is also pulling or carrying the second loading container, then it drives into a position in which the second loading container can be readily filled; it will pull forward somewhat, after the first loading container was filled and which is being pulled ahead of the second loading container. Next, the second loading container will be filled in the same way as the first loading container was filled. This process is repeated when the second loading container is filled and the discharge device is directed toward a third loading container of a third (if a transport vehicle is pulling or carrying another loading container) or second (if each transport vehicle is pulling or carrying two loading containers) transport vehicle.

In this manner not only is the successive loading of the first loading container automated, but also the change of the discharge device to the second loading container, which relieves the operator completely from the task of monitoring the transfer of the harvested crop and of operating the discharge device. The signals from the sensor arrangement are used for both tasks.

The fill level of the first loading container, as mentioned above, is detected by the sensor arrangement, which is then used to supply a different location in the loading container with crop, once the fill level at one location has reached a particular height, as described in DE 44 03 893 A1 and in EP 20 20 174 A1, the contents of which are incorporated herein by reference. The signals of the sensor arrangement can also be used to detect an overall sufficiently filled first loading container in order to initiate the change of the discharge device to the second loading container. Alternatively or additionally, the filled first loading container is detected based on a harvested crop sensor supplied at the harvesting machine to detect properties of the harvested crop. For example, the harvested crop sensor can detect the throughput, the mass, constituents and/or the dry mass of the harvested crop. The properties of the crop detected with the harvested crop sensor are integrated over time and compared to the target value and may depend on the nature (size, type etc.) of the loading container. In this case, refer to the disclosure of DE 10 2008 002 006 A1 for useful loading strategies, whose disclosure is incorporated herein by reference.

The sensor arrangement comprises preferably an imaging sensor, in particular a two-dimensional operating camera that can be used in combination with a contactless range meter, for example, one based on real time measurement using optical or acoustical waves to obtain range values for determining the fill level of the loading container. Also, a three-dimensional operating camera can be used which can be designed as a photonic mixer device. Additionally or alternatively, a range sensor can be used, in particular a laser rangefinder which senses the particular surface in two dimensions (see the disclosure in DE 10 2008 015 277 A1 incorporated herein by reference). It is expedient for the sensor arrangement to view the loading container from above. It can be attached at a suitable height to the outer end of the discharge device or to a separate mount on the harvesting machine.

The change to the discharge device from the first loading container to the second loading container can occur while driving of the harvesting machine and of the transport vehicle are continued, or the harvesting machine can stop at the initiative of the control arrangement before the discharge device switches from the first loading container to the second loading container. The transport vehicles likewise stop, or the first transport vehicle will drive off while the second transport vehicle with the second loading container takes over the position formerly held by the first loading container (if the loading containers are located on different transport vehicles), and/or the first transport vehicle can drive forward somewhat in order to position the second loading container being pulled by it next to the harvesting machine. With these embodiments, the control device can determine directly the speeds of the harvesting machine and of the transport vehicle or send appropriate instructions to their drivers.

In one preferred embodiment of the invention, the control arrangement controls the position of the second transport vehicle with the loading container with respect to the harvesting machine via a steering and/or speed definition device of the second transport vehicle automatically in order to bring it into a suitable position for transfer of the harvested crop after turning off of the first transport vehicle. But it is also possible to send corresponding instructions to the driver of the second transport vehicle via a display or a loudspeaker.

### BRIEF DESCRIPTION OF THE DRAWINGS

The embodiments of the invention are described in detail below with reference to the accompanying drawing figures, wherein:

FIG. 1 is a side view of a self-propelled harvesting machine and two transport vehicles;

FIG. 2 is a schematic, top view of the harvesting machine and the transport vehicles jointly performing a harvesting and transfer process on a field, wherein the harvested crop is transferred to the loading container of the first transport vehicle;

FIG. 3 is a rear view of the harvesting machine and of the transport vehicle from FIG. 2;

FIG. 4 is a schematic illustration of the position definition devices of the two vehicles and of the control arrangement for controlling of the transfer of the harvested crop; and,

FIG. 5 is a flow chart showing how the control arrangement functions.

### DESCRIPTION OF THE PREFERRED EMBODIMENT

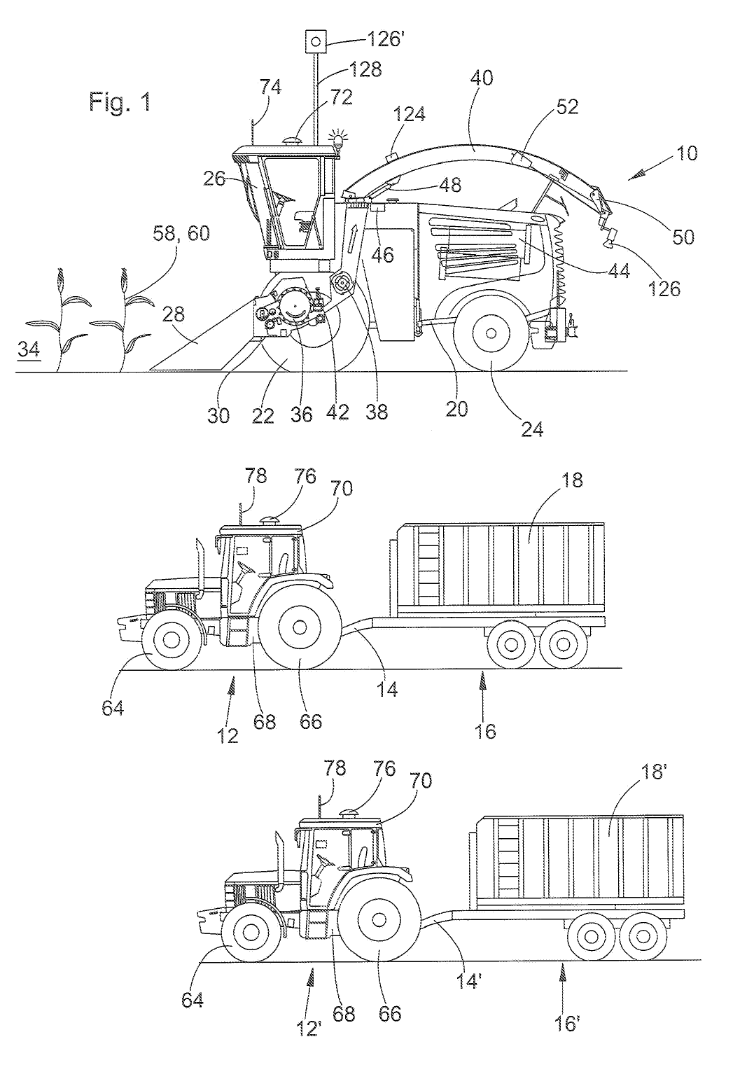

A combination of three agricultural machines illustrated in FIG. 1 comprises a harvesting machine 10, shown as a self-propelled forage harvester, a first transport vehicle 12, shown as a self-propelled tractor, which uses a drawbar 14 to pull a trailer 16 comprising a loading container 18, and a second transport vehicle 12′, shown as a self-propelled tractor, which uses a drawbar 14′ to pull a trailer 16′ comprising a loading container 18′.

The harvesting machine 10 is built on a frame 20 supported by driven front wheels 22 and steerable rear wheels 24. Operation of the harvesting machine 10 occurs from a driver's cab 26 from which a harvesting attachment 28 in the form of a corn mowing attachment is visible, which is attached to an intake duct 30 at the front side of the harvesting machine 10. Harvested crop picked up from a field 34 by the harvesting attachment 28 is sent via an intake conveyor with pre-press rollers arranged in the intake duct 30 to a chopper drum 36 which chops it into small pieces and sends it to a fan 38. Between the chopper drum 36 and the fan 38 there is a post-crushing device 42 with two grain processor rollers. The drive power of said, driven aggregate system of the harvesting machine 10 and of the harvesting attachment 28 is provided by an internal combustion engine 44. The material output from the fan 38 leaves the harvesting machine 10 to the loading container 18 driving along beside, via a discharge device 40 which can rotate about a vertical axis due to a remotely powered actuator 46. The discharge device having an adjustable angle of inclination via a second remotely powered actuator 48. The discharge device has the shape of an ejection elbow whose ejection direction is variable by means of a flap 50 whose angle of inclination is adjustable by means of a third remotely powered actuator 52. In FIG. 1 the discharge device 40 is illustrated in its idle position into which it is brought, for example, when the harvesting machine 10 is driving on a road. During the harvesting process, the discharge device 40 is raised by means of the actuator 48 and is rotated by the actuator 46 either to one side of the harvesting machine 10, if there is sufficient space for the transport vehicle 12 to the side of the harvesting machine 10 after mowing, on an already harvested region 56 of the field, or it remains in the rearward aligned position according to FIG. 1 if initially a lane is being cut in the field.

The transport vehicles 12, 12′ and the trailers 16, 16′ are of conventional design. The transport vehicles 12, 12′ each comprise steerable front wheels 64 and driven rear wheels 66 which support a frame 68 that in turn supports a driver's cab 70.

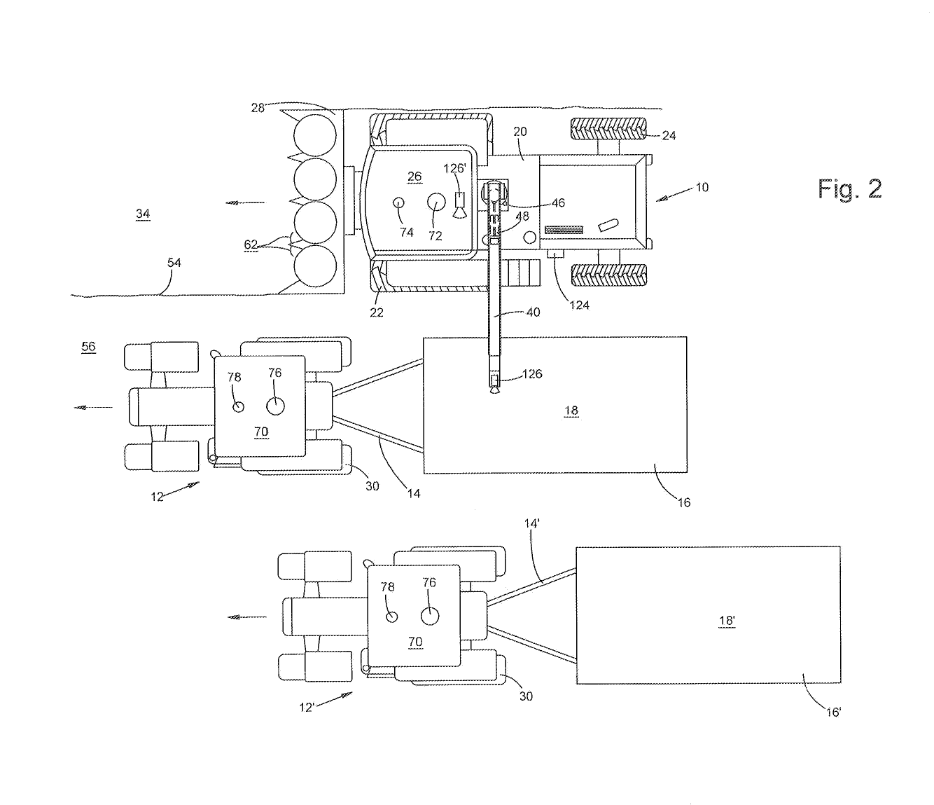

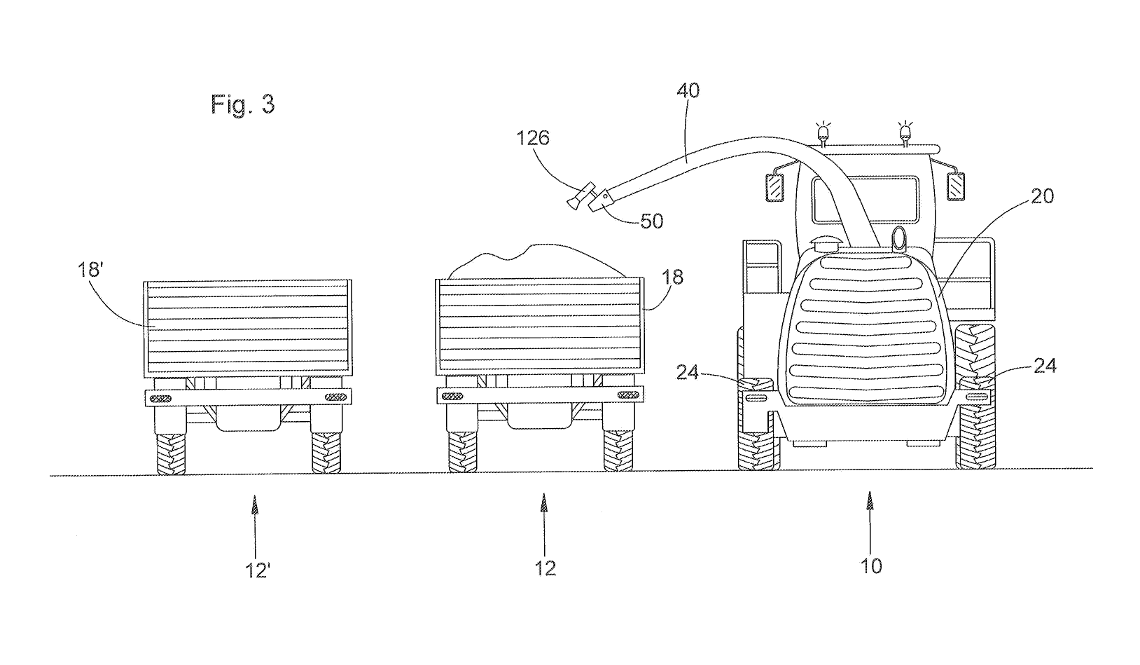

In FIG. 2 the harvesting machine 10 and the transport vehicles 12, 12′ are shown in a top view. It is thus evident that the harvesting machine 10 drives along an edge of the crop which represents a border between the harvested region 56 of the field 34 and the still standing stock 60 of the field 34 populated with corn plants 58, and is harvesting the plants 58. The first transport vehicle 12 drives on the part 56 of the field already harvested parallel to the harvesting machine 10 along a path on which the plants chopped by the harvesting machine 10 move through the discharge device 40 into the first loading container 18. Therefore the transport vehicle 12 has to drive parallel next to the harvesting machine 10; as mentioned above, the transport vehicle 12 can also drive behind the harvesting machine 10, in particular upon initial entry into the field, since at that time no harvested part 56 of the field 34 is available upon which the transport vehicle 12 could drive without damaging the plants already standing therein. While the first loading container 18 of the first transport vehicle 12 is being filled, the second transport vehicle 12′ drives along the side of the first transport vehicle 12 facing away from the harvesting machine 10 and waits to be employed. FIG. 3 shows a rear view of the situation illustrated in FIG. 2.

The harvesting machine 10 is steered by a driver seated in the driver's cab 18 or by a known, automated steering device. The transport vehicle 12 is likewise equipped with a steering device to be described in greater detail below, in order to simplify and/or to automate driving parallel to the harvesting machine 10. The harvesting machine 10 may also be any other particular self-propelled harvesting machine, such as a combine harvester or beet harvester.

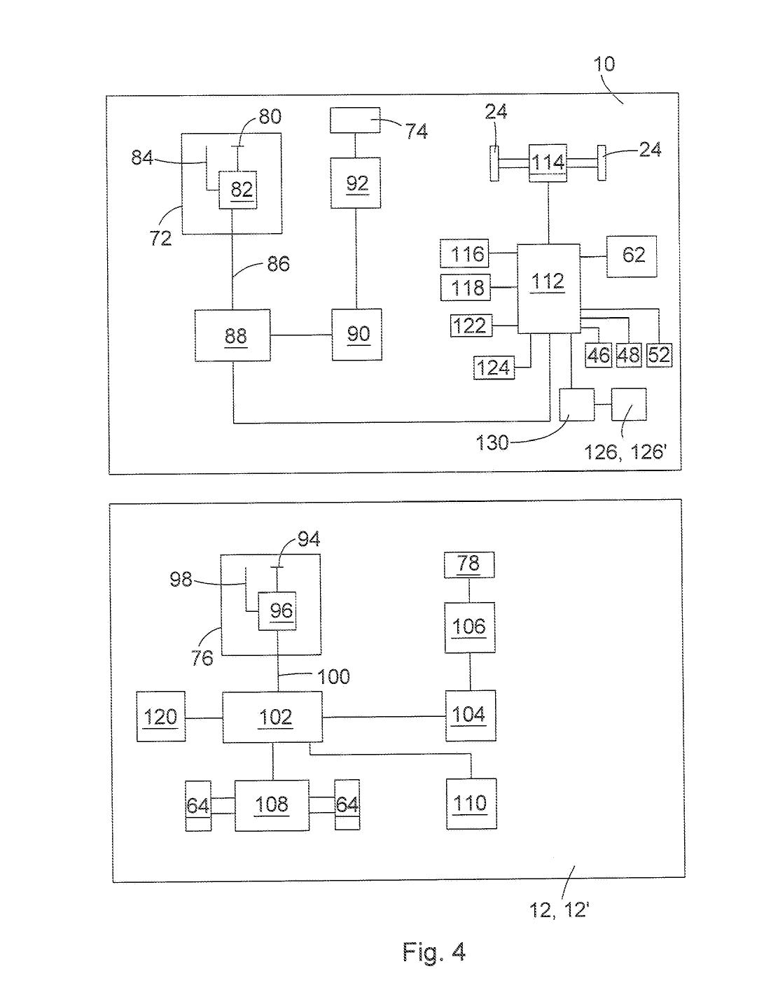

The harvesting machine 10 is equipped with a first position definition device 72 located on the roof of the cab 26. A first radio antenna 74 is also positioned thereon. The first transport vehicle 12 is equipped with a second position definition device 76 located on the roof of the cab 70. A second radio antenna 78 is also positioned thereon. The second transport vehicle 12′ is equipped with a second position definition device 76 located on the roof of cab 70. A second radio antenna 78 is also positioned thereon. In addition, the harvesting machine 10 is equipped with a sensor arrangement 126 that is arranged at the outer end of the transfer device 40 and is used to detect the contours of the loading container 18, 18′ and/or of its fill level with harvested crop. Alternatively or additionally, a sensor arrangement 126′ is attached above the roof of the cab 26 on a telescoping mount 128 that is moved into its extended position during harvest mode, as is shown in FIG. 1, and is otherwise lowered. The sensor arrangements 126, 126′ can be two-dimensional sensing ultrasound or laser rangefinders with field of view directed toward the loading containers 18, 18′, or they can be a three-dimensional operating (PMD) camera, or two cameras which produce a stereo-picture, or a two-dimensional operating camera which is combined with a rangefinder which senses the field of view. The output signal from the sensor arrangement 126 and/or 126′ is processed by a processing circuit 130 (see FIG. 4).

Reference is now made to FIG. 4 in which the individual components of the control arrangement for controlling the transfer of crop from the harvesting machine 10 to the loading containers 18, 18′ is illustrated schematically, together with the sensor arrangements 126, 126′, the position definition devices 72, 76, and the steering devices of the transport vehicles 12, 12′ and the harvesting machine 10. On board the harvesting machine 10 are the first position definition device 72 which comprises an antenna 80 and an evaluation circuit 82 associated with antenna 80. The antenna 80 receives signals from satellites of a position determining system, such as GPS, Galileo or Glonass, which are sent to the evaluation circuit 82. Based on the signals from the satellite, the evaluation circuit 82 determines the current position of the antenna 80. The evaluation circuit 82 is also connected to a correction data reception antenna 84 that receives radio waves emitted from reference stations at known sites. Based on the radio waves, correction data is created by the evaluation circuit 82 to improve the accuracy of the position definition device 72.

The evaluation circuit 82 passes its position data over a bus line 86 to a computing device 88. The computing device 88 is connected via an interface 90 to a reception- and transmission device 92, which in turn is connected to the radio antenna 74. The reception and transmission device 92 receives and generates radio waves picked up and/or emitted from the antenna 74.

Analogously, on board the transport vehicles 12, 12′ there is a second position definition device 76 each, which comprises an antenna 94 and an evaluation circuit 96 connected to the antenna 94. The antenna 94 receives signals from satellites of the same position determining system as does antenna 80, which are sent to the evaluation circuit 96. Based on the signals from the satellites, the evaluation circuit 96 determines the current position of antenna 94. The evaluation circuit 96 is additionally connected to a correction data reception antenna 98 that receives radio waves emitted from reference stations at known sites. Based on the radio waves, correction data are created by the evaluation circuit 96 to improve the accuracy of the position definition device 76.

The evaluation circuit 96 passes its position data along a bus line 100 to a computing device 102. The computing device 102 is connected via an interface 104 to a reception and transmission device 106, which in turn is connected to the radio antenna 78. The reception and transmission device 106 receives and generates radio waves that are picked up and/or emitted from the antenna 78. By means of the reception and transmission devices 90, 106 and the radio antennas 74, 78, data from the computing device 88 can be passed to the computing device 102 and vice-versa. The link between the radio antennas 74, 78 can be direct, e.g. in an approved radio range such as CB radio or such, or it can be provided via one or several relay stations, for example, when the receiving and transmission devices 90, 106 and the radio antennas 74, 78 are operating on the GSM Standard or by another suitable standard for mobile telephones.

The computing device 102 is connected to a steering device 108 that controls the steering angle of the front, steerable wheels 64. In addition, the computing device 102 sends speed signals to a speed determining device 110 which controls the speed of the transport vehicle 12, 12′ via a variation in engine speed of the transport vehicle 12, 12′ and/or by variation of the transmission ratio. In addition, the computing device 102 is connected to a permanent memory 120.

On board the harvesting machine 10 the computing device 88 is connected to a control unit 112; this control unit, together with its controlled actuators and its connected sensors forms the control arrangement for controlling the transfer of the crop from the harvesting machine 10 to the loading container 18 of the transport vehicle 12. The control unit 112 is connected to a steering device 114 that controls the steering angle of the rear, steerable wheels 24. In addition, the control unit 112 passes speed signals to the speed determining device 116 which controls the speed of the transport vehicle 12 via a variation of the transmission ratio. Further, the control unit 112 is connected to a volume sensor 118 which detects the distance between the pre-press rollers in the intake duct, with a sensor to detect the position of sensing bars 62 arranged on a divider peak of the harvesting arrangement 28, with a permanent memory 122, with processing circuit 130, and with the actuators 46, 48 and 50.

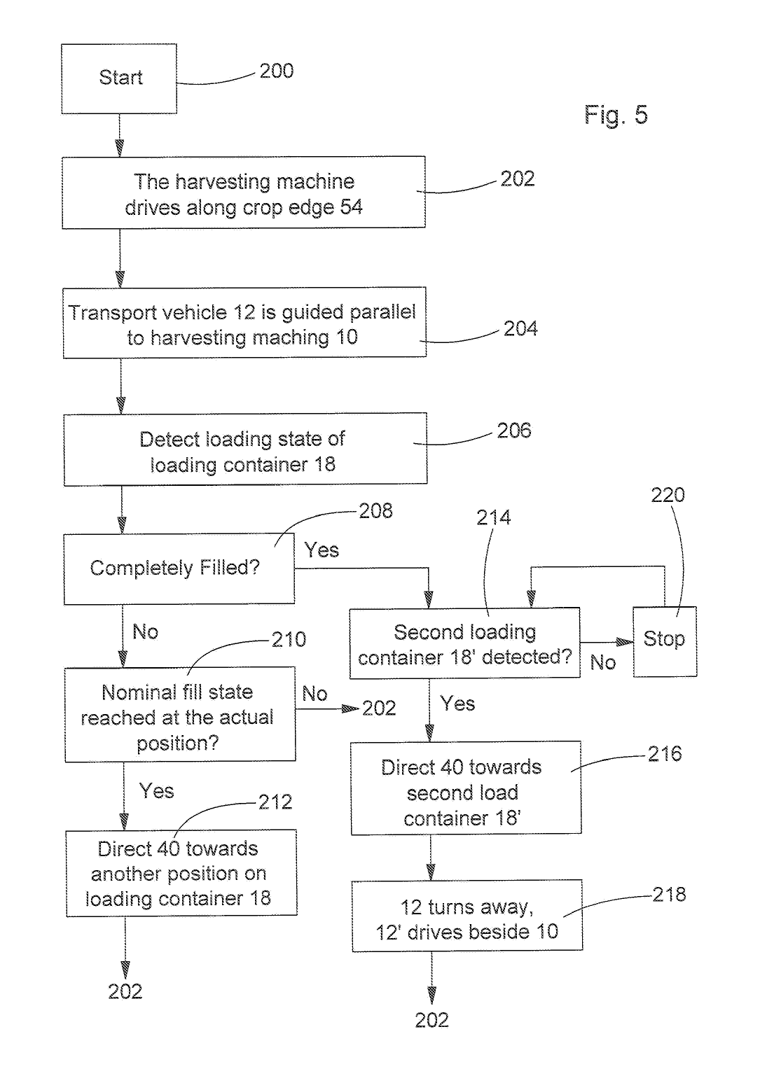

FIG. 5 illustrates a flow diagram showing the progress of the control unit 112 of the harvesting machine 10 during the harvesting operation.

After the start at step 200, at step 202 the harvesting machine 10 is guided along the edge of the crop 54, while the control unit 112 sends steering signals to the steering device 114 which are based on the signals from the position definition device 72 and a map saved in memory 112 which define a path planned for the coming harvest process, or based on signals from the sensing bar 62 or on a combination of both signals. As an alternative or in addition, the edge of the crop 54 can be detected with a two or three-dimensional camera and a picture processing system or a laser- or ultrasonic sensor or scanner and used to generate the steering signal for the steering device 114. The path of the harvesting machine 10 need not necessarily run in a straight line, but rather can also include curves, depending on the shape of the field. In addition, turn-around processes at the end of the field are also included.

The speed of advance of the harvesting machine 10 can be defined by its driver, or the control unit 112 uses the throughput signals from the throughput sensor 118 to control the speed definition device 116 so that a desired throughput through the harvesting machine 10 is achieved.

In addition, at step 204 the transport vehicle 12 is guided parallel to the harvesting machine 10, in that the control device 112 sends data via the computing device 88 and the radio antennas 74, 78 to the computing device 102 regarding the steering position of the transport vehicle 10. The computing device 102 then controls the steering device 108 and the speed definition device 110 accordingly, in that it compares the position detected by the position definition device 76 with the target position, and then depending on the result of the comparison, outputs suitable steering signals to the steering device 108. This comparison and the generation of the steering signal for the steering device 108 could also be handled by the computing device 88 and/or the control unit 112 on board the harvesting machine 10, wherein the position data are passed from the position definition device 76 of the transport vehicle via the radio antennas 74, 78 to the harvesting machine 10, while the steering signals are passed in the reverse direction back to the transport vehicle 12. Transport vehicle 12 follows the harvesting machine 10 even when driving along the curves and when turning around at the end of the field.

At step 206 the load state of the loading container 206 is detected and the signals from the processing circuit 130 are used for this; these signals can be supplemented by or replaced by highly integrated signals from the throughput sensor 118 and/or signals from a sensor 124 to detect crop constituents. Step 208 is a decision step to determine whether it is sufficiently or completely filled. If this is not the case, then step 210 follows, in which a determination is made of whether a target fill level has been reached at the location of the loading container 18 currently filled with crop. If this is not the case, then the program proceeds to step 202, otherwise to step 212, in which the discharge device 40 is directed to another location of the loading container 18. In this case a particular loading strategy can be used and reference is made to the disclosure of DE 10 2008 002 006 A1, which is incorporated herein by reference.

The signals from the processing device 130 are then used at step 212 to control the actuators 46, 48, 52. Additionally or alternatively, the position of the transport vehicle 12 in the forward direction and/or in the lateral direction is varied with respect to the harvesting machine 10, in that the control unit 112 sends to the computing device 102 corresponding data via the computing device 88 and the radio antennas 74, 78 regarding the target position to be steered to by the transport vehicle 10. Therefore, the path of the crop between the output end of the discharge device 40 and the loading container 18 can be kept relatively short, which has the advantage that fewer crop losses will occur with wind and the crop will be pre-compressed on the loading container 18. After step 212, the program returns to step 202.

If it is determined at step 208 that the loading container is entirely filled, then the program continues to step 214 in that the control unit 112 checks the data from the processing unit 130 to determine whether a second loading container 18′ is detected therein. If this is not the case, then the program continues to step 220, in that the harvesting machine 10 is stopped and awaits a second transport vehicle 12′ with a second loading container 18′, whereupon the program continues to step 214. However, if a second loading container 18′ is detected, the program continues to step 216 in that the discharge device 40 is directed to the second loading container 18′, in that the actuators 46, 48, 52 are controlled in a suitable manner. At step 218 the first transport vehicle 12 turns aside, i.e., decelerates and then drives to the unloading site for the crop, and as soon as sufficient space is available, the second transport vehicle 12′ takes up the position directly next to the harvesting machine 10 which was previously held by the first transport vehicle 12. At step 218 the driver of the transport vehicle 12 may be prompted by an information device (not shown) operating optically or acoustically by the control unit 112 via the computing devices 88, 102 to assume control over the transport vehicle 12 and to make space available next to the harvesting machine 10 for the second transport vehicle 12′. Alternatively, the steering unit 108 of the transport vehicle 12 can be actuated to decelerate the latter and then to drive it off to the side, whereupon the driver of transport vehicle 12 will assume the controls. The second transport vehicle 12′ will be positioned by its driver or automatically via the computing devices 88, 102 next to the harvesting machine 10.

If the first transport vehicle 12 has two trailers 16, 16′ each with one loading container 18, 18′ towed in tandem (not illustrated in the figures), then preferably the front (first) loading container is filled first and subsequently the rear (second) loading container.

In addition it would be possible to stop the harvesting machine 10 automatically between steps 214 and 216 in order to allow the transport vehicles 12, 12′ to change position and then to resume the harvesting operation.

It should be noted that in a simplified embodiment of the invention the driver of the harvesting machine 10 can steer it directly and specify its speed, while the driver of the transport vehicle 12 steers it and determines its speed. The control unit 112 will then only control the actuators 46, 48 and 52 and direct the discharge device 40 with the filled, first transport container 18 automatically to the second transport container 18′, based on data from sensor arrangement 126, 126′.

Having described the preferred embodiment, it will become apparent that various modifications can be made without departing from the scope of the invention as defined in the accompanying claims.

The invention claimed is:

1. A control arrangement for controlling the transfer of agricultural crop from a harvesting machine to a transport vehicle, the transport vehicle comprising a loading container, the control arrangement being operated based on signals from a sensor arrangement detecting at least one of a fill level and an outer contours of the loading container to control the position of at least one of an output end of a discharge device with respect to the harvesting machine, an ejection direction of the discharge device, and the position of the transport vehicle with the loading container with respect to the harvesting machine, automatically in such a manner that the loading container is successively filled with crop, wherein:
the sensor arrangement detects a position of a second loading container and the control arrangement is operated so that after a detection of a sufficiently filled first loading container, the discharge device will be automatically aligned to the second loading-container based on the signals from the sensor arrangement.

2. A control arrangement according to claim 1, wherein the control arrangement is operated so as to detect a sufficiently filled first loading container based on signals from at least one of the sensor arrangement and a crop sensor arranged on the harvesting machine for detecting at least one of the properties of the crop such as a throughput, a mass, a constituents, and a dry weight thereof.

3. A control arrangement according to claim 1, wherein the sensor arrangement comprises an imaging sensor, that is one of a two-dimensional operating camera, a three-dimensional operating camera, and a two-dimensional sensing range meter.

4. A control arrangement according to claim 1, wherein the control arrangement is operated to align the discharge device during driving of the harvesting machine to the second loading container.

5. A control arrangement according to claim 1, wherein the control arrangement is operated to stop the harvesting machine before it aligns the discharge device to the second loading container, wherein at least one of the transport vehicles likewise stop and the second loading container moves to the position which the first loading container previously held.

6. A control arrangement according to claim 1, wherein the control arrangement is operated to control the position of at least one of the first and the second transport vehicle with the second loading container automatically with respect to the harvesting machine.

7. A control arrangement according to claim 1, wherein that the sensor arrangement senses the loading container from above.

8. A control arrangement according to claim 1, wherein the sensor arrangement is attached to at least one of an outer end of the discharge device and a separate mount on the harvesting machine.

9. A method for transfer of agricultural crop from a harvesting machine to a transport vehicle comprising a loading container, the control arrangement being operated based on signals from a sensor arrangement detecting at least one of a fill level and an outer contours of the loading container to control the position of at least one of an output end of a discharge device with respect to the harvesting machine, the ejection direction of the discharge device and the position of the transport vehicle with the loading container with respect to the harvesting machine, automatically in such a manner that the loading container is successively filled with the crop, wherein:
the sensor arrangement detects the position of a second loading container and after detection of a sufficiently filled first loading container, the control arrangement is operated so that the discharge device is automatically aligned to the second loading container based on the signals from the sensor arrangement.
